(19) United States
(12) Patent Application Publication
(10) Pub. No.: US 2018/0135680 A1
(43) Pub. Date: May 17, 2018

(54) METHOD FOR ASSEMBLING EQUIPMENT ON A SUPPORT OF A TURBOMACHINE

(71) Applicant: Nuovo Pignone Tecnologie Srl, Florence (IT)

(72) Inventors: Fabio FORNACIARI, Florence (IT); Leonardo TOGNARELLI, Florence (IT); Alessandro PACCIANI, Florence (IT); Mario BIGI, Florence (IT)

(21) Appl. No.: 15/576,105

(22) PCT Filed: May 25, 2016
(86) PCT No.: PCT/EP2016/061783

§ 371 Date: Nov. 21, 2017

(30) Foreign Application Priority Data
May 25, 2015 (IT) 102015000017463

(51) Int. Cl. F16B 19/00; F01D 25/28; F16B 37/06

(52) U.S. Cl. CPC F16B 19/008; F01D 25/28; F16B 37/067; F05D 2260/95; F05D 2230/90; F05D 2300/44; F05D 2230/60

(57) ABSTRACT

A method for assembling equipment on a support of a turbo-machine. The method comprises the step of mechanically assembling the equipment to a part of the support by means of a fastening device and a further step consisting of providing a coating layer of resin at the interface between the fastening device and the support part. The coating layer allows to perfectly seal the interface between the fastening device and the support part thus avoiding the oxidation of the internal surface without painting.

### FIELD OF INVENTION

The present invention relates to a method for assembling equipment on a support of a turbomachine.

More specifically, the present invention concerns a method for mechanically assembling electrical packaging, tubing, piping and similar equipment as well as supports for gas and steam turbine and/or centrifugal compressor to a skid, without welding.

### BACKGROUND OF THE INVENTION

In the field of turbomachine implants, comprising gas or steam turbine and compressor, it is known to provide a base support, named skid, to which electrical cables, tubing and piping as well as the gas or steam turbine and compressor are firmly coupled.

Electrical packaging is a set of cable trays, and related supports, for protecting electrical cables; tubing is the set of channels for fluid supplying (primary and pneumatic tubing); the turbine and the compressor are supported by means of mechanical supports, i.e. a support bracket; all the supports of these equipment must be connected to the support skid, and they are assembled in situ by means of welding.

A critical aspect of the gas/steam turbine and compressor equipment assembly in turbomachine implants relates to oxidation: the whole implant assembly is exposed to an aggressive environment, especially when the implants are placed on off-shore platforms. It is therefore mandatory that all the components and assembled parts of an oil and gas implant are protected against corrosion.

The support is therefore painted with a special protective coating and sealed.

The known welding process illustrated above is affected by several drawbacks.

The first drawback consists of the fact that the assembly process is a manual process, comprising a phase of welding, resulting to be expensive, time consuming, and difficult to keep controlled in terms of quality of the overall process.

A further drawback is represented by the fact that the welding process has a significant impact on lead times and costs of implementation of the skid.

Furthermore, the welding process imposes design and manufacturability constraints such as the accessibility to the welding are.

Another drawback of the welding assembly process is represented by the high costs of the painting phase of the welding area of the surface of the base-plate.

### BRIEF DESCRIPTION OF THE INVENTION

An embodiment of the present invention relates to a method for assembling equipment on a support of a turbomachine.

More in detail, the present invention concerns a method for assembling electrical packaging, tubing, piping and similar equipment as well as supports for gas or steam turbine and centrifugal compressor to a skid, without welding.

Usually, turbomachine are assembled on a skid, and therefore the assembling on a skid will be considered hereafter in the description, but the method of an embodiment of the present invention relates to the assembly of a turbomachine on a support in general, e.g. on a beam of support.

The customer has the possibility to decide how and in which point of the skid to position the equipment, and therefore the assembling operations are performed manually by an operator by means of welding the equipment to the skid directly in situ.

The welding of the equipment's supports on the skid needs several preparatory operations such as the surface milling of the baseplate area at which the supports are welded, the sub-sole plate pre-fixing, the sub-sole plate final welding and, after the welding, the further painting of the surface of the baseplate around the welding area with a protective coating and, finally, the support assembly.

According to an embodiment of the present invention, the method for assembling such equipment to the support of a turbo-machine comprises the step of mechanically assembling said equipment by means of a fastening device.

In an embodiment, said fastening device comprises a rivet nut.

According to an embodiment, the fastening device is specially designed in order to prevent the oxidation of internal surfaces without painting.

According to a first aspect of the invention, the method for assembling equipment to a support according to an embodiment of the present invention comprises the step of mechanically assembling said equipment to a part of a support by means of a fastening device and the step consisting of providing a coating layer at the interface between the fastening device and the support part, wherein said coating layer is in an embodiment a layer of epoxy resin or alternatively of anaerobic resin.

According to an embodiment of the invention, the fastening device comprises a rivet nut provided, on its external surface, along its entire length and under the head of the rivet nut, a coating of resin, in an embodiment of an epoxy resin, more more particularly of microencapsulated epoxy resin, or of an anaerobic resin. Entire length means the portion of the fastening device that can be inserted in the support part.

The rivet nut may in this case be surrounded by a solid layer of resin, along its whole external surface, in an embodiment except for the bottom surface of its free end opposite to the head, i.e. along its entire length and under the head and except for the upper portion of the head.

Alternatively, the coating in a semi-solid or viscous form, may be applied on the external surface, i.e. along its whole external surface except for the bottom surface of its free end opposite to the head, i.e. along its entire length and under the head.

According to an embodiment of the invention, the epoxy or anaerobic resin is placed directly on the support part to which the equipment has to be assembled, in an embodiment directly on the perimeter of a fixing hole provided on the support part.

As it will be more clear in view of the detailed description given here below, the rivet nut may have a blind or a passing threaded hole.

Each of said alternative shape of the rived nut may be provided with a solid coating, with a semi-solid or viscous coating directly provided on the rivet nut.

Alternatively, either with the rivet having a blind hole or a passing hole, the epoxy or anaerobic resin is placed directly on the support part to which the equipment has to be assembled, in an embodiment directly on the perimeter of a fixing hole provided on the skid part.

According to a further aspect of the present invention, the fastening device further comprises a sealing element, in an embodiment an O-ring, more more particularly an O-ring made of NBR or FKM.

### BRIEF DESCRIPTION OF THE DRAWINGS

Further details and specific embodiments will refer to the attached drawing, in which:

FIG. 1 is perspective view of a skid to which equipment are assembled;

FIG. 2 is a schematic view of a conduit or packaging for electric cables, welded to said skid according to the prior art;

FIG. 3 is a schematic view of a tubing assembly for hydraulic lines to be welded to said support skid according to the prior art;

FIG. 4A shows a rivet nut;

FIG. 4B shows a rivet nut;

FIG. 4C shows a rivet nut according to the embodiment of FIG. 4A provided with a solid coating on its external surface;

FIG. 4D shows a rivet nut according to the embodiment of FIG. 4B provided with a solid coating on its external surface;

FIG. 5 shows the assembling sequence of a rivet nut to a support;

FIGS. 5A and 5B show an enlarged view of a rivet nut after the upset and with a fixing screw inserted therein respectively;

FIG. 6 shows the assembling sequence of a rivet nut to a support;

FIG. 7 shows a section view of a possible configuration of the assembly of a conduit packaging to a support;

FIG. 8 shows a general view of a possible assembly configuration of a conduit packaging to a support;

FIG. 9 shows a general view of a possible assembly configuration of tubing equipment to a support.

### DETAILED DESCRIPTION

The following description of an exemplary embodiment refers to the accompanying drawings. The following detailed description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various point of the specification is not necessarily referring to the same embodiment. Further, the particular features, structures or characteristics may be combined in any suitable manner in one or more embodiments.

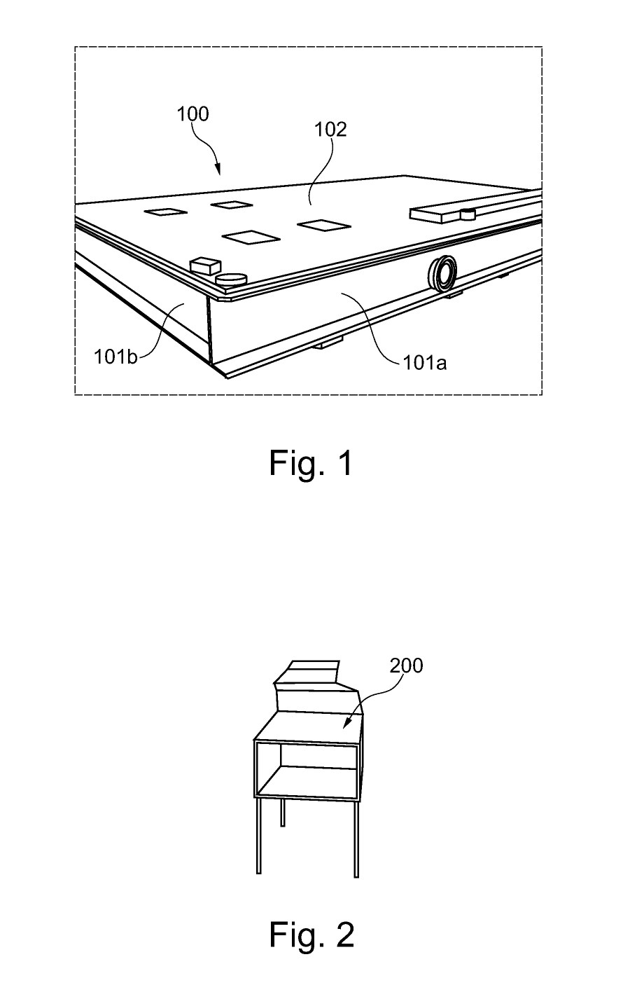

With reference to FIG. 1, it is shown a typical skid 100 for supporting the equipment of oil and gas implants.

More specifically, the skid 100 is configured as a closed case with a lower base plate 101a and an upper cover plate 102. Within the skid case, electrical cables, tubing for hydraulic lines and similar equipment are usually stably connected to a skid part 101, said skid part 101 could be the base plate 101a or to the inner surface of the lateral vertical walls 101b. The skid part 101 is schematically represented in Figures from 5 to 9, and the skid part may be any part of the skid suitable to support the equipment.

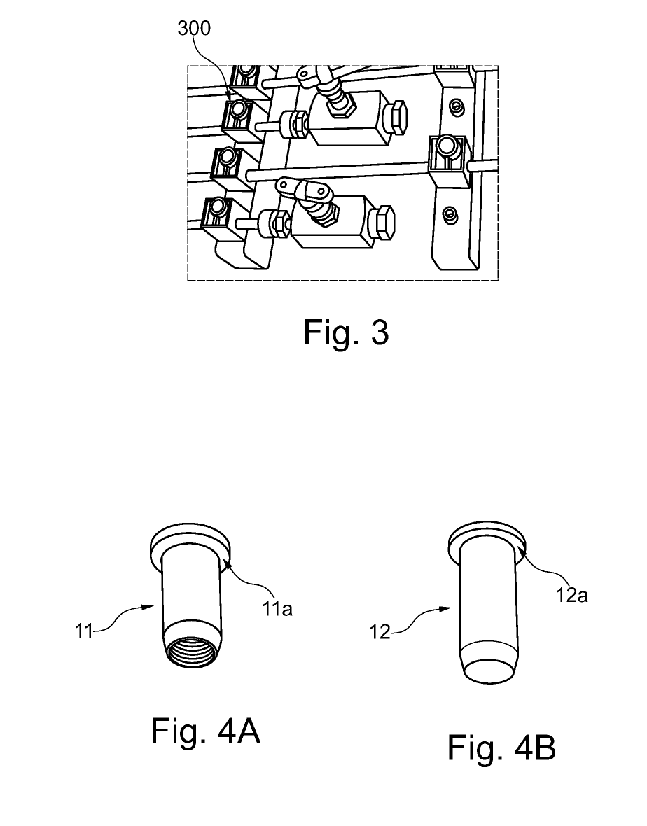

FIG. 2 shows a typical electrical packaging 200 for electrical cables, and FIG. 3 shows a typical arrangement for the tubing 300. The electrical packaging and the tubing assembly are typical equipment that are stably connected to the skid 100 by means of welding operations.

More in details, support brackets for the electrical packaging 200, for the tubing assembly 300 and/or for turbine and compressor are welded to an area of the baseplate 101 or of the inner surface of the lateral walls 101a, 101b and the equipment are then connected to said support brackets.

As already mentioned, in order to weld the brackets to the skid several preparatory and touching up operations are required: the surface area to which the brackets will be welded need to be manually milled, then the brackets need to be pre-fixed to said area and then the operator proceeds manually with the final welding. After the welding operation, is it mandatory to paint the area around the welding in order to avoid corrosion of the skid area.

With the method of an embodiment of the present invention, the welding phase is completely avoided.

The method for assembling equipment on a support according to an embodiment of the present invention comprises the step of mechanically assembling said equipment to the support skid 100 by means of a fastening device 10.

Said fastening device 10 comprises at least a rivet nut 11, 12.

According to a first embodiment, said rivet nut 11 has a passing threaded hole.

According to a second embodiment, said rivet nut 12 has a blind threaded hole.

Rivet nut 12 with a blind threaded hole are used for example when the fastening device is fixed to a support which communicates with an aggressive environment, for example when a tank for containing aggressive vapors and/or liquid is fixed to a support, and in general when it is mandatory to avoid, with respect to the support or skid part to which the fastening device 10 is associated, any communication between the internal and external environments.

Irrespective of whether the rivet nut has a passing threaded hole or a blind threaded hole, the fastening device 10 further comprises a fixing screw 20 for joining the skid part 101 once the rivet nut has been plastically deformed by means of a screwdriver 40 used to pull-out the rivet.

When the rivet nut deforms, a swelling 11b is created in contact with the lower surface 101c of said skid part 101.

The method for assembling equipment on a support according to an embodiment of the present invention further comprises a step consisting of realizing a fixing hole 30 on the skid part 101 for the insertion of the fastening device 10.

More in detail, the fixing hole 30 is realized on the skid, in an embodiment by means of a step drill. More in an embodiment, the step drill has at least three different diameters. In an embodiment, the first diameter is of 4 mm for realizing the center ground, the second diameter is approximately 1 mm smaller than the last step, and the last step is boring tool.

In an embodiment, the hole preparation phase comprises the use of a driller with a variable speed gear and during the drilling phase the drill is kept in vertical position with respect to the skid surface using dedicated equipment. Once the fixing hole 30 has been realized, the burrs are removed from the hole, especially from the contour of the hole.

Once the hole 30 in the skid has been realized, the rivet nut can be inserted into the hole 30 and pulled-out by means of the screwdriver 40.

An interface area between the rivet nut and the skid part 101 is therefore defined.

The interface area is mainly represented by: the contact surface between the inner surface of the fixing hole 30 and the lateral surface of the rivet nut; the contact surface between the rivet swelling 11b and the lower surface 101c of the skid part 101; the contact surface between the collar of the head 11a, 11b of the rivet nut and the upper surface 101a of the skid part 101.

The rivet nut 11, 12 is in an embodiment made of stainless steel, more in an embodiment austenitic stainless steel, in order to prevent oxidation, especially in off-shore application. According to an embodiment, the rivet nut is made of stainless steel AISI 316 L.

The method according to an embodiment of the present invention further comprises a step consisting of providing a coating layer 50 at the interface area between the rivet nut 11, 12 and the skid part 101.

In an embodiment, said coating layer 50 is provided at least at the interface between the internal surface of the hole 30 and the external surface of the rivet nut 11, 12.

According to one aspect of the invention, said coating is made of epoxy or anaerobic resin. More particularly said epoxy resin is a microencapsulated epoxy resin.

When the rivet nut is pulled-on and plastically deformed by the screwdriver, the coating layer at the interface follows the rivet deformation: during deformation of the rivet the coating is compressed on the lower side of the skid part 101. The coating is trapped between the crimped nut and the skid part 101 and the presence of the resin perfectly seals the interface between the nut and the skid part avoiding the risk of oxidation.

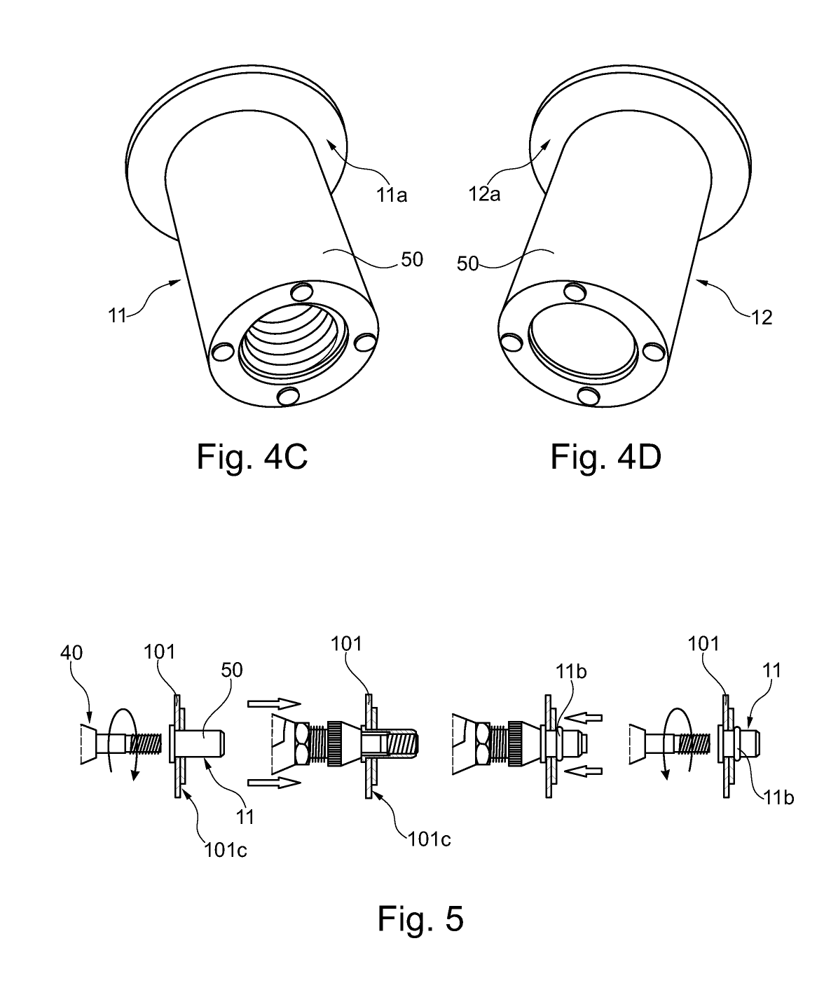

According to an embodiment, the fastening device comprises a rivet nut 11, 12 provided on its external surface facing the hole 3 and along its entire length, thus the portion inserted in the hole, with a coating 50 made of resin. More particularly said external coating 50 of resin embraces the whole external surface of the rivet nut, particularly the lower surface of the rivet head 11a, 12a. Reference is made to FIGS. 4C and 4D.

In an embodiment, the external coating is made of epoxy resin or anaerobic resin, in an embodiment of microencapsulated epoxy resin. During the deformation of the rivet the microencapsulated spheres containing the epoxy resin are broken in order to release a flow of epoxy resin that fills the gap between the crimped nut and the skid part.

According to an embodiment of the present invention, the coating layer 50 is provided on the internal surface of the fixing hole 30 of the skid part 101.

Reference is made to FIG. 6.

Once the rivet has been inserted into the fixing hole 30 it is pulled-out and plastically deformed. After this operation the resin is compressed on the lower side of the skid part 101, the opposite side of the skid with respect to the direction head of the rivet nut.

During the deformation of the rivet nut the resin is trapped between the crimped rivet and the skid part and this seals the area.

In an embodiment, the fastening device 10 further comprises a sealing element 60.

In an embodiment, said sealing element 60 is an O-ring which is positioned below the collar. The O-ring allows to have a sealed coupling when the rivet nut is assembled and the O-ring is compressed.

When the resin 50 is positioned directly on the internal surface of the fixing hole 30, the resin itself fills the space between the lower surface of the rivet head 11a, 12a and the skid part 101 to which the rivet is fixed.

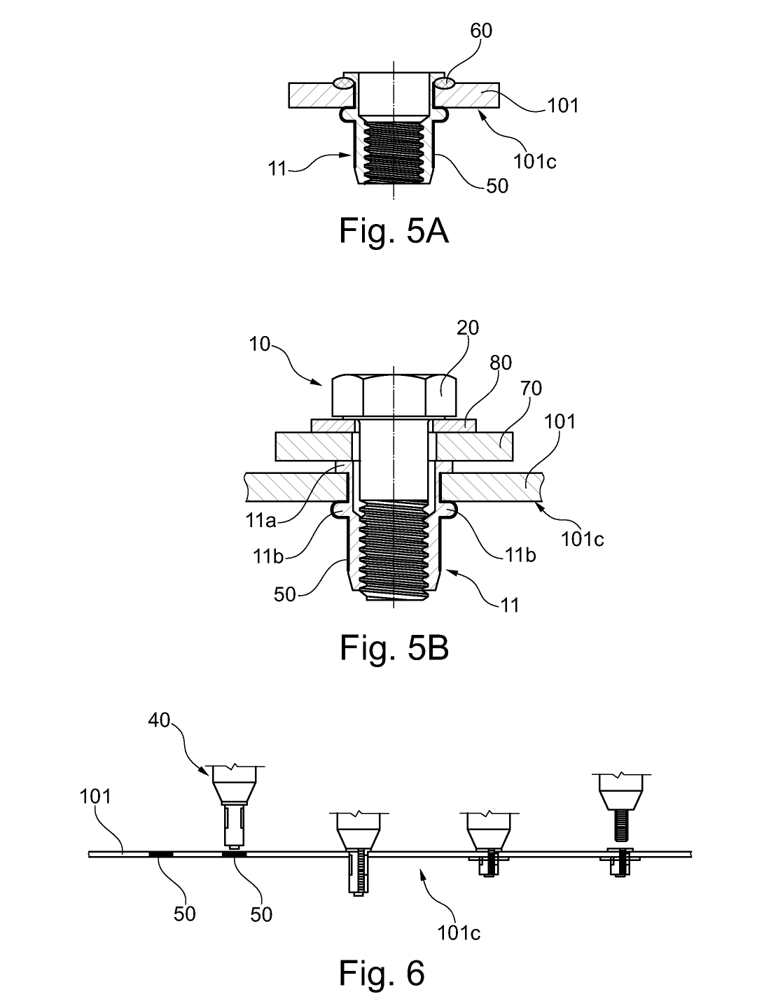

With reference to FIG. 5B, once the rivet nut 11, 12 has been fixed to the skid part 101, the bracket or support element 70 which has to be fixed to the skid part can be positioned and fixed by means of the fixing screw 20 which is screwed into the rivet nut.

A washer 80 is in an embodiment inserted between the head of the fixing screw 20 and the bracket 70.

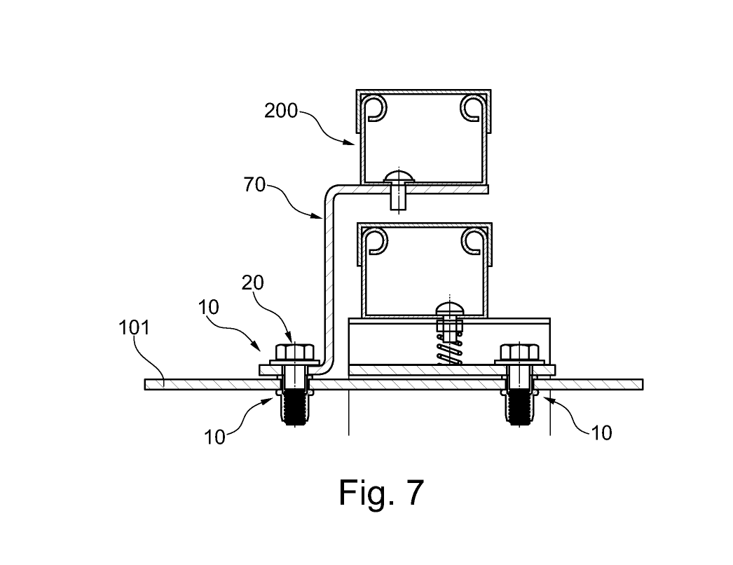

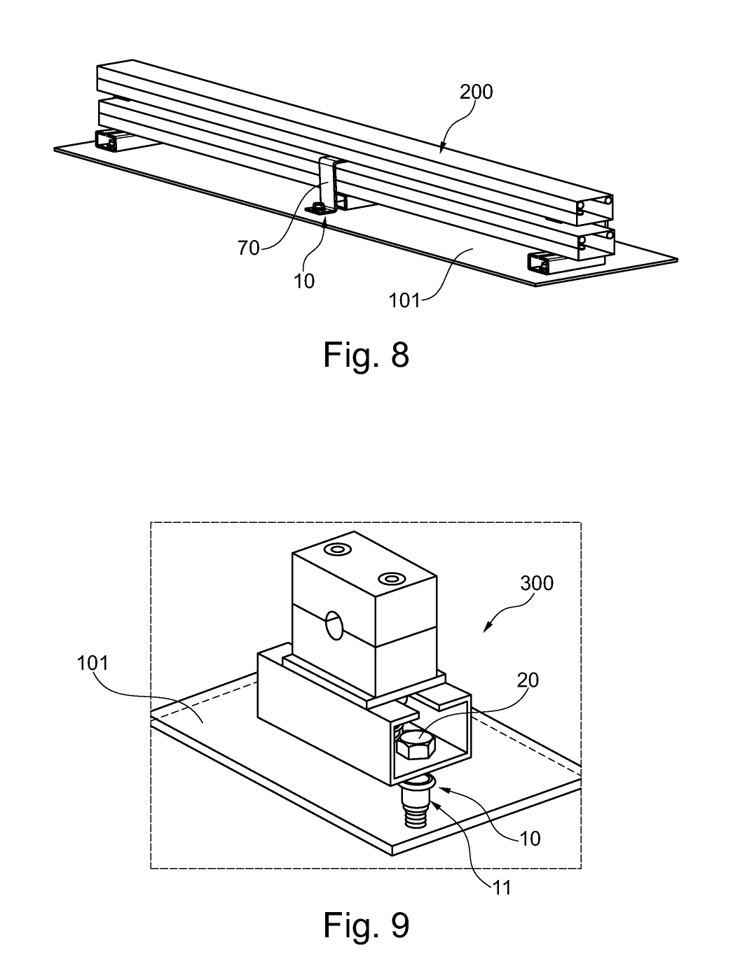

Possible examples of bracket for electrical packaging 200 are given in FIGS. 7 and 8. Possible example of tubing assembly 300 is given in FIG. 9.

The method for assembling equipment on a skid according to an embodiment of the present invention allows to reduce the lead time and the related cost of the traditional welding process, and at the same time it prevents the oxidation of the internal surfaces without painting.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What we claim is:

1. A method for assembling equipment on a support of a turbomachine, the method comprising
mechanically assembling the equipment to a part of the support with a fastening device; and and
adding a coating layer of epoxy resin at an interface area between the fastening device and the support part.

2. The method according to claim 1, wherein the fastening device comprises a rivet nut.

3. The method according to claim 2, wherein the step of mechanically assembling the equipment to the support part comprises:
realizing a fixing hole (30) on the support part;
deburring of internal edge fixing hole;
inserting the rivet nut in the fixing hole thus defining the interface area between the rivet nut and the support part;
adding with a coating layer the interface area; and
plastically deforming the rivet nut thus firmly assembling the rivet nut to the support part.

4. The method according to claim 1, wherein the adding with a coating layer the interface area between the rivet nut and the support part further comprises adding a coating layer on the external surface of the rivet nut.

5. The method according to claim 1, wherein the adding with a coating layer the interface area between the rivet nut and the support part further comprises the step of adding a coating layer on the internal surface of the fixing hole.

6. The method according to claim 1, wherein the step of mechanically assembling the equipment to the support part further comprises the following:
coupling a support bracket to the rivet nut and
inserting a fixing screw into the rivet nut thus firmly assembling the support bracket to the support part to which the rivet nut is assembled.

7. The method according to claim 1, wherein the coating of epoxy resin is a solid coating of a microencapsulated epoxy resin.

8. The method according to claim 7, wherein the coating of epoxy resin is arranged on the external surface of the rivet nut facing the support part.

9. The method according to claim 7, wherein the coating of epoxy resin is arranged on the lower surface of the rivet head.

10. The method according to claim 2, wherein the rivet nut is made of stainless steel, preferably an austenitic stainless steel.

11. The method according to claim 1, wherein the fastening device further comprises a sealing element, preferably an O-ring, placed between the rivet head and the support part.

12. The method according to claim 1, wherein the sealing element is made of NBR or FKM.

13. The method according to claim 1, wherein the support is a skid of a turbomachine.

14. The method according to claim 1, wherein the rivet nut has a passing threaded hole.

15. The method according to claim 1, wherein the rivet nut has a blind threaded hole.
